(19) United States
(12) Patent Application Publication
(10) Pub. No.: US 2007/0190502 A1
(43) Pub. Date: Aug. 16, 2007

(54) System and method for creating a simulation of a terrain that includes simulated illumination effects

(75) Inventor: Brett Chladny, Plano, TX (US)

Correspondence Address: PILLSBURY WINTHROP SHAW PITTMAN, LLP, P.O. BOX 10500, MCLEAN, VA, 22102, US

(73) Assignee: MultiGen-Paradigm Inc., Plano, TX (US)

(21) Appl. No.: 11/342,684

(22) Filed: Jan. 31, 2006

(51) Int. Cl. G09B 29/00

(52) U.S. Cl. 434/150

(57) ABSTRACT

A system and method for creating a simulation of a terrain that enables simulated views of the terrain to be rendered. The simulated views may include illumination effects (e.g., shading) that correspond to simulated illumination conditions. The simulated views may be substantially devoid of illumination effects present in one or more images of the terrain from which the simulation is created. Thus, the simulation may provide the simulated views with realistic, dynamic illumination effects, which may enhance an overall realism of the simulation.

### FIELD OF THE INVENTION

The invention relates to creating a simulation of a terrain from one or more images of the terrain, wherein the simulation includes illumination effects that correspond to simulated illumination conditions.

### BACKGROUND OF THE INVENTION

In conventional electronic simulations of a terrain, a database of visual information, or a visual database, related to the terrain may enable simulated views of the terrain to be rendered. The visual information in the visual database may include geometric information (e.g., three dimensional geometric information), color information, texture information, and/or other information. Some of the visual database is typically derived from images of the terrain. For example, satellite images and/or other aerial images may be used.

Generally, although various aspects of the simulated views may be altered for the sake of the simulation, illumination effects (e.g., reflections, shading, shadows, etc.) present in the original images of the terrain may not be removed. This may decrease the realism of the simulated views, as the simulated views may be intended to simulate the terrain under different illumination conditions than the original images (e.g., different times of day, different times of the year, etc.).

Additionally, illumination effects corresponding to simulated illumination conditions of the simulated views usually not to the simulated views, or are provided “on top of” the illumination effects already present in the imagery of the terrain. This may be attributed, at least in part, to the fact that the original illumination effects are typically not removed. Further, adding illumination effects at each vertex in a simulated view may be expensive from a processing standpoint and/or terrain geometry within the terrain may not provide enough detail to derive illumination effects. This lack of illumination effects corresponding to simulated illumination conditions may further decrease the realism of the simulated views.

### SUMMARY

One aspect of embodiments of the invention relates to creating a simulation of a terrain that enables simulated views of the terrain to be rendered. The simulated views may include illumination effects (e.g., shading) that correspond to simulated illumination conditions. The simulated views may be substantially devoid of illumination effects present in one or more images of the terrain from which the simulation is created. Thus, the simulation may provide the simulated views with realistic, dynamic illumination effects, which may enhance the overall realism of the simulation.

In one implementation, the realistic illumination effects may be included in the simulated views without the use of a shader. For example, the OpenGL fixed function pipeline and one or more ARB extensions may be used to provide per-pixel color adjustment of the simulated views during the rendering of the simulated views to generate the illumination effects. Providing the illumination effects to the simulated views without the use of a vertex or fragment shader may reduce a processing cost associated with the illumination effects, may enable the generation of the illumination effects by one or more modules that render the simulated views when these modules may not support a vertex or fragment shader, and/or provide other benefits.

Another aspect of the invention may relate to a method of creating a simulation of a terrain. In one implementation, the method may comprise capturing at least one image of the terrain, generating an illumination-neutral visual database from the at least one image, and using the illumination-neutral visual database to simulate the terrain.

Another aspect of the invention may relate to a method of generating an illumination-neutral visual database associated with a terrain. In one implementation, the method may comprise obtaining elevation data associated with the terrain, obtaining image information associated with an image of the terrain, wherein the image information comprises a capture time at which the image was captured, location information related to the location of the terrain, position information related to a position from which the image was captured, and a visual database that enables a view of the terrain to be rendered, estimating one or more illumination conditions at the location of the terrain at the capture time based on the image information, determining one or more illumination effects of the illumination conditions in the image information based on the illumination conditions and the elevation data, and removing the determined illumination effects from the visual database to create an illumination-neutral visual database that enables an illumination-neutral view of the terrain to be generated.

Another aspect of the invention may relate to a method of using an illumination-neutral visual database to simulate a terrain. In one implementation, the method may comprise obtaining one or more simulated illumination conditions, and rendering the simulated view of the terrain including one or more simulated illumination effects, wherein the simulated view is rendered from the illumination-neutral visual database, the elevation data, and the simulated illumination conditions.

Another aspect of the invention may relate to a system for creating a simulation of a terrain. In one implementation, the system may comprise an input interface, a first processor, and an electronic storage. The input interface enables elevation data associated with the terrain and image information associated with an image of the terrain to be input to the system. The image information comprises a capture time at which the image was captured, location information related to the location of the terrain, position information related to a position from which the image was captured, and a visual database that enables a view of the terrain to be rendered. The first processor executes an illumination conditions module, an illumination effects module, and an effects removal module. The illumination conditions module estimates one or more illumination conditions at the location of the terrain at the capture time based on the image information. The illumination effects module determines one or more illumination effects of the illumination conditions in the image information based on the illumination conditions and the elevation data. The effects removal module removes the determined illumination effects from the visual database to create an illumination-neutral visual database that enables an illumination-neutral view of the terrain to be generated. The illumination-neutral visual database and the elevation data are stored in the electronic storage.

In one implementation, the system further comprises a simulated illumination conditions module and a view rendering module. The simulated illumination conditions module and the view rendering module may be executed on the first processor or a second processor. The simulation illumination conditions module may obtain simulation illumination conditions. The view rendering module may render a simulated view that includes one or more simulated illumination effects from the simulation illumination conditions, an illumination-neutral visual database associated with the terrain, and elevation data associated with the terrain.

These and other objects, features, benefits, and advantages of the invention will be apparent through the detailed description of the preferred embodiments and the drawings attached hereto. It is also to be understood that both the foregoing general description and the following detailed description are exemplary and not restrictive of the scope of the invention.

### BRIEF DESCRIPTION OF THE DRAWINGS

FIG. 1 illustrates a system for creating a simulation of a terrain, in accordance with one embodiment of the invention.

FIG. 2 is a graphical illustration of a visual database associated with an image of a terrain, according to one embodiment of the invention.

FIG. 3 is a graphical illustration of a visual database associated with an image of a terrain, according to one embodiment of the invention.

FIG. 4A is a graphical illustration of a visual database associated with an image of a terrain, according to one embodiment of the invention.

FIG. 4B is a graphical illustration of simulated illumination effects associated with an image of a terrain, according to one embodiment of the invention.

FIG. 5 illustrates a method of creating a simulation of a terrain, in accordance with one embodiment of the invention.

FIG. 6 illustrates a method of generating an illumination-neutral visual database of a terrain, in accordance with one embodiment of the invention.

FIG. 7 illustrates a method of processing elevation data related to a terrain, according to one embodiment of the invention.

FIG. 8 illustrates a method of simulating a terrain using an illumination-neutral visual database, according to one embodiment of the invention.

### DETAILED DESCRIPTION

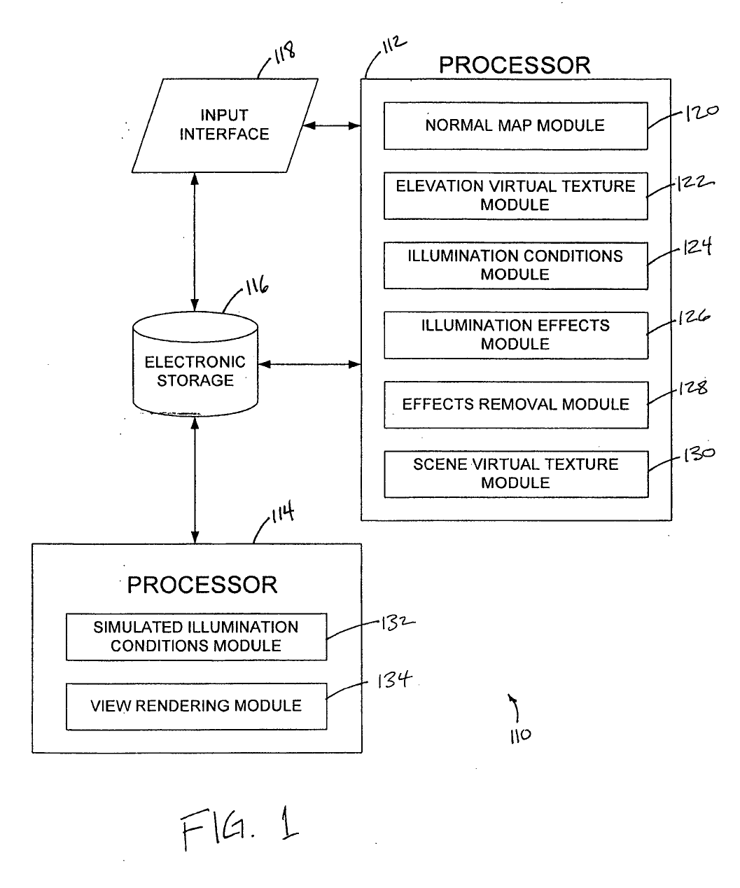

FIG. 1 illustrates a system 110 for creating a simulation of a terrain, in accordance with one implementation. The system 110 may enable simulated views of the terrain to be rendered with illumination effects (e.g., shading, etc.) corresponding to simulated illumination conditions (e.g., angle of simulated illumination, color of simulated illumination etc.). System 110 may include one or more processors (illustrated in FIG. 1 as processor 112 and processor 114), an electronic storage 116 and an input interface 118.

In one implementation, input interface 118 may be operatively linked to one or both of processor 112 and electronic storage 116. Input interface 118 may include an interface that enables data and/or information to be input to system 110 from an external source. For example, the external source may include an electronic-readable storage medium such as a removable disk (e.g., a dvd, a cd, a floppy, etc.), a non-removable data storage drive (e.g., a magnetic hard disk, a tape storage, etc.), a solid-state storage device (e.g., a USB connectable flash drive, etc.), or other electronic-readable storage media. Input interface 118 may include an electronic-readable storage medium reading device (e.g., a disk drive, a USB port, etc.), a port, a receiver, and/or a connector that enables a link with an electronic-readable storage medium (e.g., a modem port, a wireless communication receiver, etc.).

According to one implementation, processor 112 may execute one or more modules to generate an illumination-neutral visual database associated with a terrain. The modules may include a normal map module 120, an elevation virtual texture module 122, an illumination conditions module 124, an illumination effects module 126, an effects removal module 128, a scene virtual texture module 130, and/or other modules. Each of modules 120, 122, 124, 126, 128, and 130 may be implemented in hardware, software, firmware, or in some combination thereof. Modules 120, 122, 124, 126, 128, and 130 may be executed locally to each other, or one or more of modules 120, 122, 124, 126, 128, and 130 may be executed remotely from other ones of modules 120, 122, 124, 126, 128, and 130.

Normal map module 120 may generate a normal map of a terrain from a height field of the terrain. The height field may be obtained by processor 112 input interface 118, from electronic storage 116, or may be obtained by processor 112 from another source. The height field may include elevation information of the terrain that describes the elevation of the terrain at predetermined locations within the terrain (e.g., at predetermined coordinate intervals, etc.). For example, the height field may include one or more DTED files, DEM files, DED files, and/or other height field files.

In some instances, the accuracy of the normal map generated by normal map module 120 may impact downstream processing in system 110. To reduce negative effects caused by inaccuracy in the normal map, normal map module 120 may process the information included in the height field to enhance the accuracy of the normal map generated therefrom. One such implementation may include processing the information included in the height field to smooth the information as the normal map is generated.

For example, a DTED file may include height values expressed as integers and not as float (e.g., a “row” of data may read as [ . . . 7 7 7 7 8 8 8 8 . . . ]). Since the terrain described by such data is probably somewhat smoother than this representation, this type of data may cause plateauing and/or banding type artifacts in the normal map. The normal map module 120 may smooth the data by converting the data to a float as the normal map is generated in order to avoid such artifacts. Smoothing the data may include modifying the height values where two “groups” of height values are found adjacent to each other to “blend” the groups together (e.g., modifying the “row” of data presented above to [ . . . 7.0 7.0 7.2 7.4 7.6 7.8 8.0 8.0 . . . ]). Running a Gaussian blur across the modified height values may further reduce banding and/or plateauing artifacts, but may also reduce the detail of relatively fine terrain features. Other methods for reducing banding and/or plateauing artifacts in the normal map may be implemented.

Elevation virtual texture module 122 may generate a virtual texture of elevation data associated with a terrain. For example, elevation virtual texture module 122 may generate a virtual texture of a normal map generated by normal map module 120.

Illumination conditions module 124 may determine one or more illumination conditions that may have been present when an image of a terrain (e.g., an aerial image, a satellite image, etc.) was captured. The illumination conditions may be determined based on image information associated with the image, the image information being obtained by processor 112 from input interface 118, from electronic storage 116, or from another source. The image information may include a capture time at which the image was captured, location information related to the location of the terrain, position information related to a position from which the image was captured (e.g., a satellite position for a satellite image), a visual database that enables a view of the terrain to be rendered (e.g., the visual database may include shape information, color information, etc.), and/or other information. In one implementation, the image information associated with an image may be obtained by processor 112 substantially concomitantly. In another implementation, the image information may be obtained by processor 112 at different times. For example, a visual database may be obtained separately from one or more of a capture time, location information, and/or position information.

In one implementation, the illumination conditions may include the positions of one or more light sources that illuminated the terrain when the image was taken. More specifically, the illumination conditions may include the position of a celestial light source (e.g., the sun, the moon, etc.) and/or an angle of illumination provided therefrom at the capture time. For example, the capture time may include a date, a time of day, or other temporal information, and illumination conditions module 124 may determine a position of the sun and/or an angle of illumination provided therefrom.

In some instances, some of the image information may be imprecise. For instance, the capture time may identify a time window over which a plurality of component images that form the image were captured (e.g., where a satellite image is actually a composite of multiple images). In such instances, the imprecise information may be averaged, or otherwise approximated. In the instance in which the capture time identifies a time window, a midpoint of the time window, the start time of the time window, or the end time of the time window may be used as the capture time.

The illumination conditions may also include weather conditions present at the terrain when the image was captured. However, in one implementation in which the image is a satellite image, the weather conditions may be approximated as clear based on the ability of a satellite to take a usable image.

Illumination effects module 126 may determine the illumination effects present at a terrain when an image was captured. The illumination effects may be determined based on elevation data associated with the terrain (e.g., a height field, a normal map, a virtual texture generated from a normal map, etc.) and illumination conditions when the image was captured. For instance, based on the elevation data and an illumination angle derived from position information related to a celestial light source, including for example, shading, and/or other effects from the illumination provided by the celestial light source present at the terrain when the image was taken may be determined. In one implementation, illumination effects module uses the shape of the terrain and the position of a celestial light source (e.g., the sun) to determine the amount of light that each pixel of the terrain received when the image was captured.

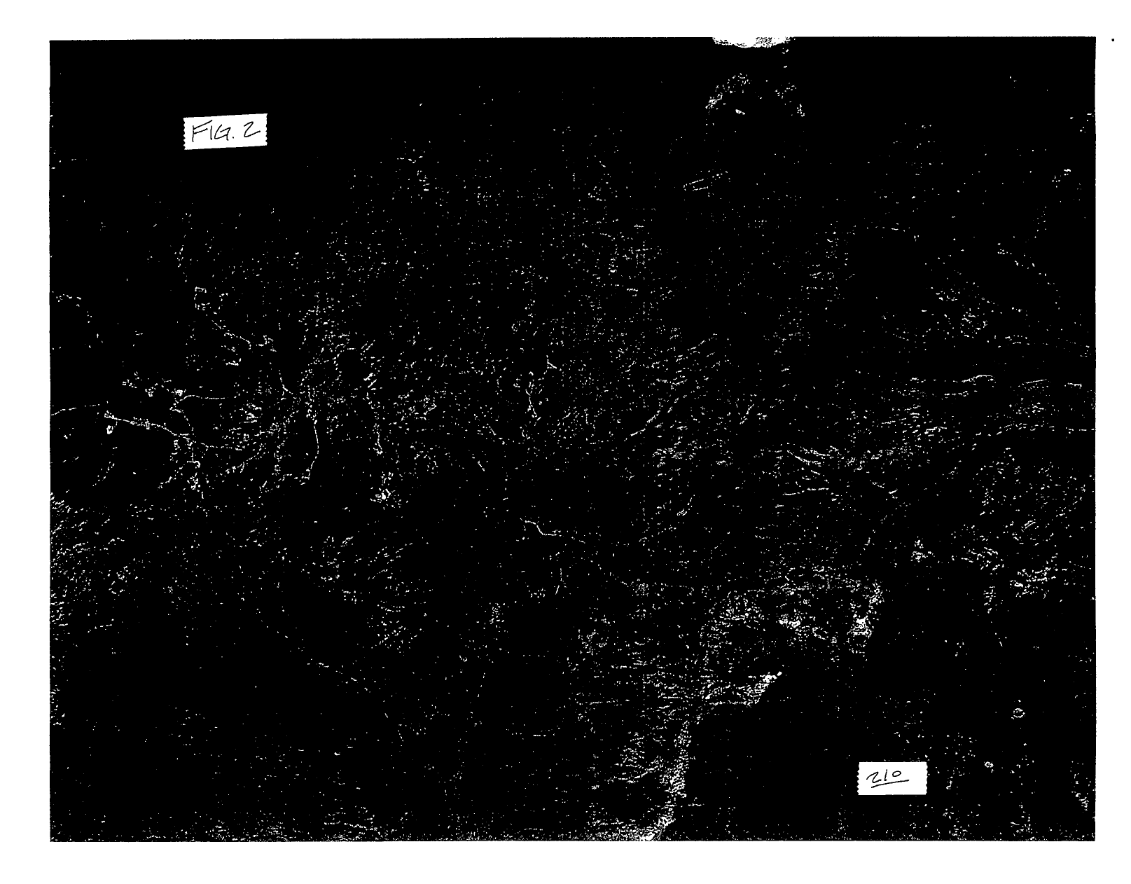

For example, FIG. 2 is a graphical illustration of a view of a terrain 210 rendered from a visual database associated with terrain 210. Terrain 210 may include one or more terrain features caused by adjacent sections of terrain 210 by different elevations. The terrain features may include manmade features, natural features, or other terrain features.

Due to the differences in elevation that result in the terrain features, illumination from a celestial light source (e.g., the sun) may cause illumination effects including shading, reflection, etc. The illumination effects may be manifested as differences in color between adjacent portions of terrain 210 (e.g., the adjacent portions may be darker, lighter, etc., with respect to each other). As was mentioned above, the size, shape, and/or amount of color change of the illumination effects may depend on one or more factors that may be determined from elevation data and/or image information related to the image of terrain. These factors may include a shape of the terrain (e.g., terrain features, etc.) determined from elevation information related to the terrain, illumination conditions, and/or other factors. Illumination effects module 126 may determine, or predict, the size and/or shape of illumination effects, and/or the color changes caused by the illumination effects present in the visual database associated with terrain 210 based on the dependence of illumination effects on these factors.

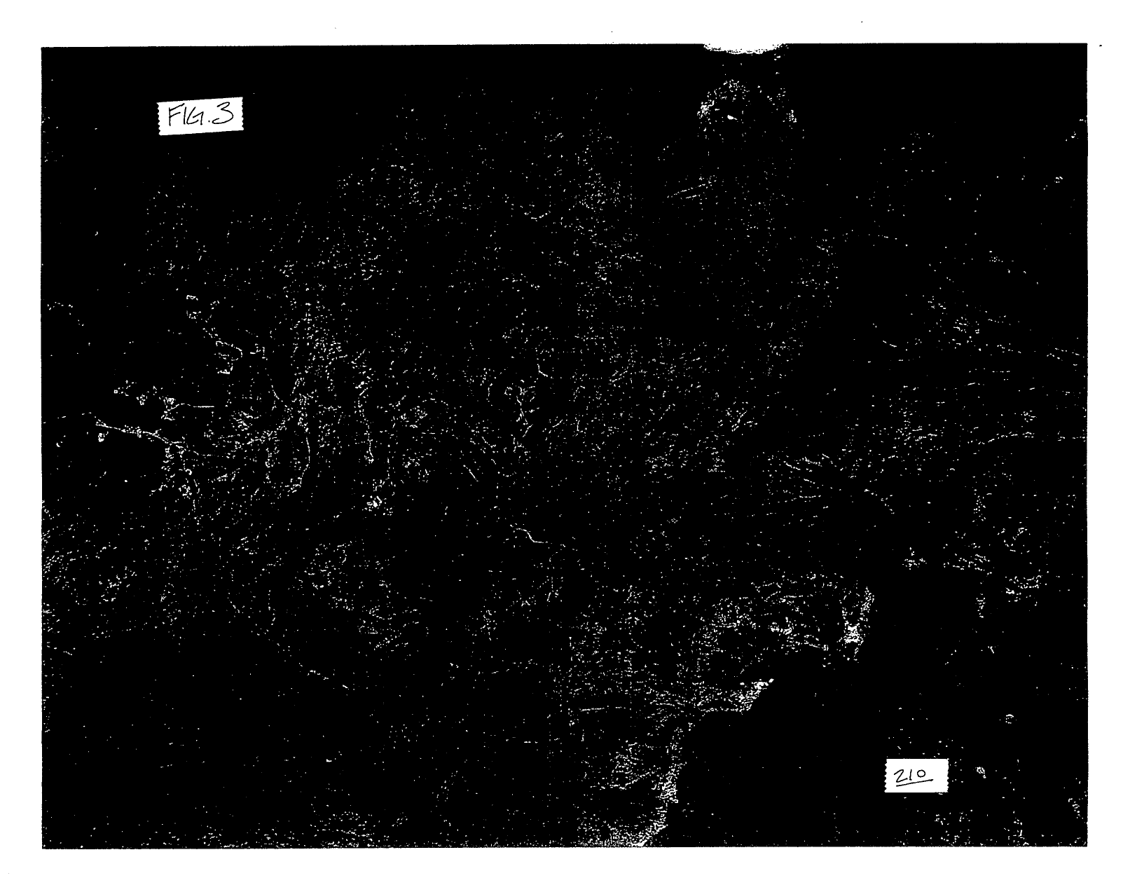

Effects removal module 128 may remove illumination effects from the visual database associated with a terrain to generate an illumination-neutral visual database associated with the terrain. The illumination effects may be removed by modifying color information in the visual database associated with areas of the terrain so that the visual database represents what the terrain would look like if each pixel of the terrain associated with the visual database received the same amount of light. For example, FIG. 3 is a graphical illustration of a view rendered from an illumination-neutral visual database associated with terrain 210 (previously depicted in FIG. 2). In the view rendered from the illumination-neutral visual database associated with terrain 210, the illumination effects shown in FIG. 2 may be effectively removed due to the modification of color information associated with the terrain from the original visual database to the illumination-neutral visual database.

Returning to FIG. 1, scene virtual texture module 130 may generate a virtual texture from an illumination-neutral visual database associated with a terrain. For example, scene virtual texture module 122 may generate a virtual texture of an illumination-neutral visual database generated by effects removal module 128. In one implementation, virtual texture modules 122 and 130 may be combined into a single module that provides the functionality of both of these modules.

According to one implementation, electronic storage 116 may include an electronic-readable storage medium such as a removable disk (e.g., a dvd, a cd, a floppy, etc.), a non-removable data storage drive (e.g., a magnetic hard disk, a tape storage, etc.), a solid-state storage device (e.g., a USB connectable flash drive, etc.), or other electronic-readable storage medium. One or both of processors 112 and 114 may be operatively linked to electronic storage 116. Over this operative link, an illumination-neutral visual database (e.g., illumination-neutral visual database, a virtual texture generated from illumination-neutral visual database, etc.) associated with a terrain may be provided to electronic storage 116 for storage therein. The illumination-neutral visual database may include elevation data (e.g. a height field, a normal map, a virtual texture generated from a normal map, etc.).

In one implementation, processor 114 may execute one or more modules to simulate of a terrain from an illumination-neutral visual database associated with the terrain. The modules may include a simulated illuminations conditions module 132, a view rendering module 134, and/or other modules. Each of modules 132, 134, and/or 136 may be implemented in hardware, software, firmware, or in some combination thereof. Modules 132 and/or 134 may be executed locally to each other, or modules 132 and/or 134, may be executed remotely from one another.

Simulated illumination conditions module 132 may obtain one or more simulated illumination conditions. The simulated illumination conditions may be obtained from a software application generating a simulation of a terrain. In one implementation, the software application may include modules 132 and 134. The simulated illumination conditions may include a position of a simulated celestial light source, an angle of simulated illumination, a color of ambient and/or diffuse light, and/or other illumination conditions.

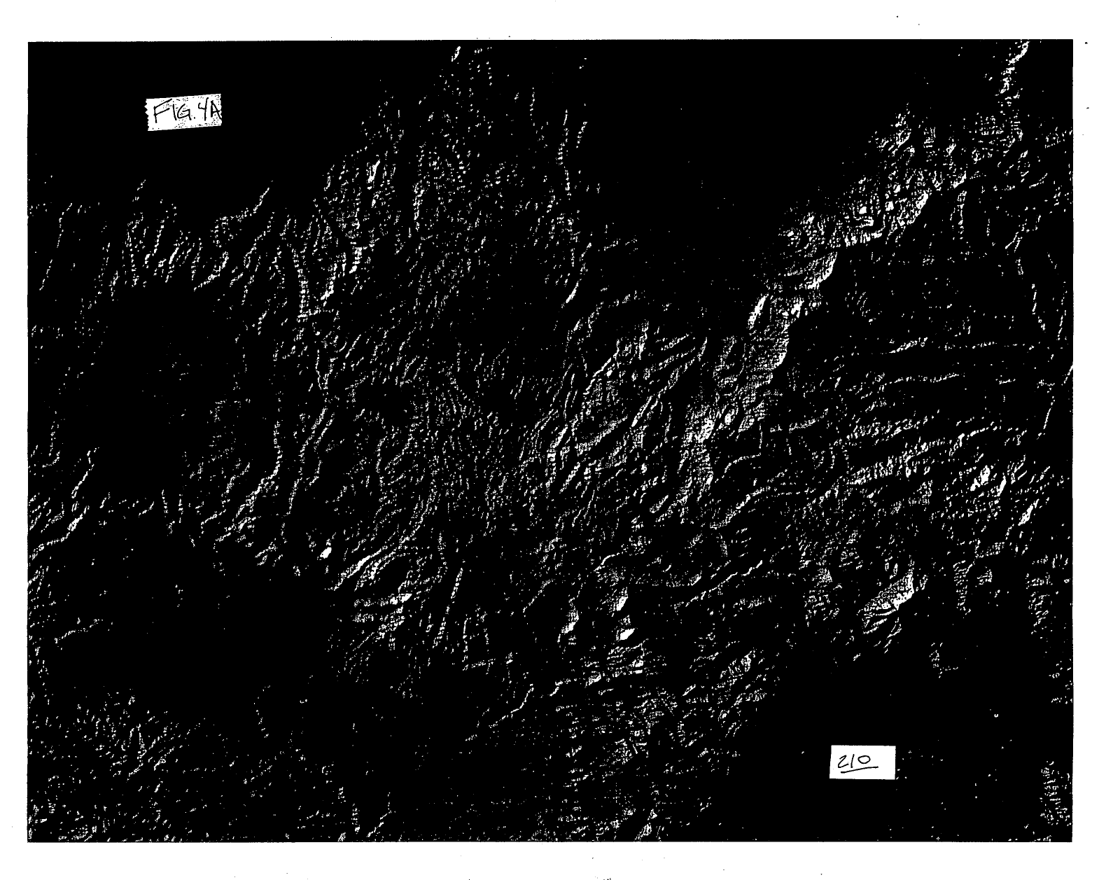

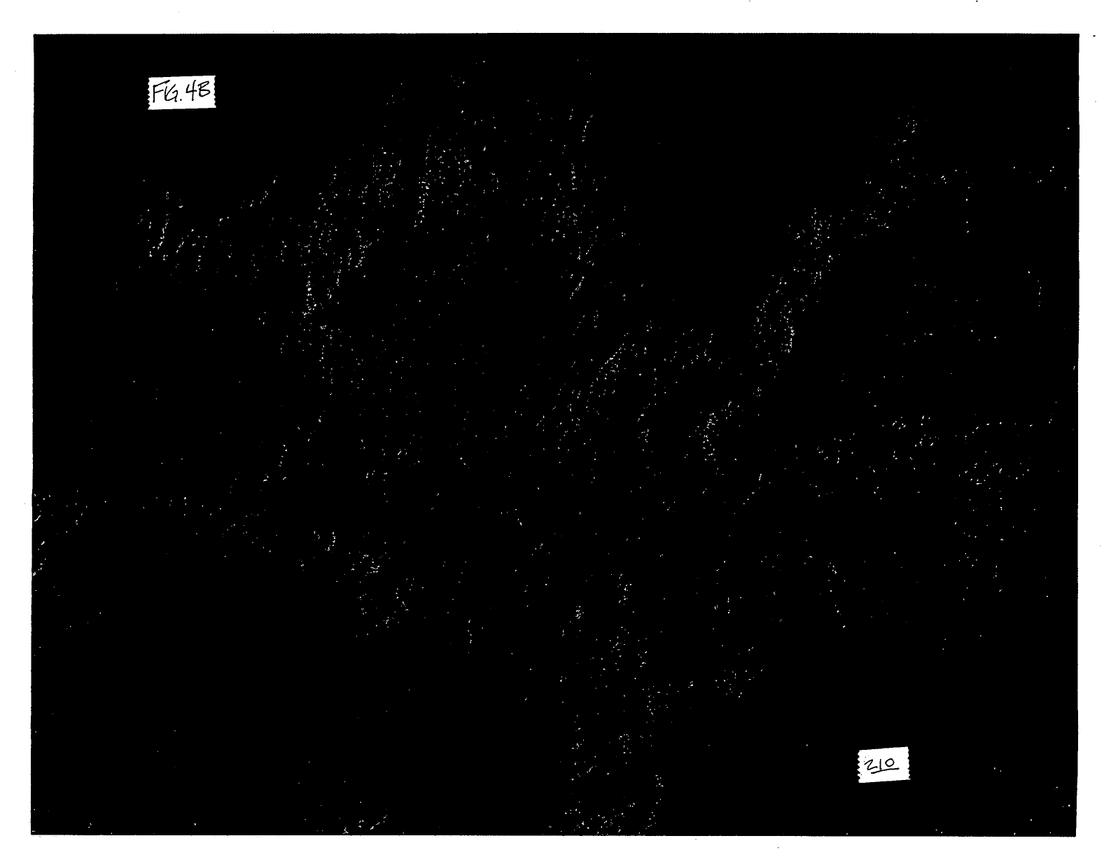

View rendering module 134 may render a simulated view of a terrain that includes simulated illumination effects. The simulated view may be rendered from an illumination-neutral visual database associated with the terrain (e.g., illumination-neutral visual database, a virtual texture generated from illumination-neutral visual database, etc.), which may include elevation data (e.g., a height field, a normal map, a virtual texture generated from a normal map, etc.), and one or more simulated illumination conditions (e.g., an angle of simulated illumination, etc.). For illustrative purposes, FIG. 4A shows a simulated view of terrain 210 (depicted in FIGS. 2 and 3) including one or more simulated illumination effects that correspond to simulated illumination conditions different than the illumination conditions under which the image of terrain 210 was captured. FIG. 4B represents the simulated illumination effects separate from the information related to the shape, color, etc. of terrain 210 included in the illumination-neutral visual database associated with terrain 210.

Simulated illumination effects may be provided to the simulated view by modifying color information included in the illumination-neutral visual database as the simulated view is rendered. For example, the simulated illumination effects illustrated in FIG. 4B may be provided to the illumination-neutral visual database of terrain 210 shown in FIG. 3 to generate the simulated view of FIG. 4A by a shader.

As another example, the simulated illumination effects illustrated in FIG. 4B may be provided to the illumination-neutral visual database associated with terrain 210 shown in FIG. 3 to generate the simulated view of FIG. 4A in a fixed function OpenGL pipeline that leverages the elevation data and the angle of simulated illumination to modify the color information as the simulated view is rendered. For instance, through the use of the ARB extension GL_ARB_texture_env_combine, most of the OpenGL lighting equation can be reproduced for one infinite light source and an all white material. The full light equation is:

Lvec=Light direction vector

Nvec=Normal vector

Svec=Unit vector half way between view vector and light vector

Shininess=Polygon's material properly

Ambient=RGB ambient color of light

Diffuse=RGB diffuse color of light

Specular=RGB diffuse color of light
Ambient+((Lvec·Nvec)*Diffuse)+((Svec·Nvec)^{shininess}*Specular)
Since terrains simulated by processor 114 may rarely be shiny, this equation may be simplified to:
Ambient+((Lvec·Nvec)*Diffuse)

To turn this equation into something that can be executed by the fixed function OpenGL pipeline, three texture stages and the GL_ARB_texture_env_combine extension may be implemented. An example of electronically-readable code for performing this functionality (e.g., in Vega Prime) may include:

// Lvec · Nvec
m_texBlendUnit0 = new vrTextureBlend( );
m_texBlendUnit0->setColorMode(vrTextureBlend::MODE_DOT);
m_texBlendUnit0->setCombineEnable(true);
m_texBlendUnit0->setColorArgument(0,
vrTextureBlend::ARGUMENT_TEXTURE_COLOR);
m_texBlendUnit0->setColorArgument(1,
vrTextureBlend::ARGUMENT_BLEND_COLOR);
// (Lvec · Nvec) * Diffuse
m_texBlendUnit1 = new vrTextureBlend( );
m_texBlendUnit1
->setColorMode(vrTextureBlend::MODE_MODULATE);
m_texBlendUnit1->setCombineEnable(true);
m_texBlendUnit1->setColorArgument(0,
vrTextureBlend::ARGUMENT_PREVIOUS_COLOR);
m_texBlendUnit1->setColorArgument(1,
vrTextureBlend::ARGUMENT_BLEND_COLOR);
// Ambiant + ((Lvec · Nvec) * Diffuse)
m_texBlendUnit2 = new vrTextureBlend( );
m_texBlendUnit2->setColorMode(vrTextureBlend::MODE_ADD);
m_texBlendUnit2->setCombineEnable(true);
m_texBlendUnit2->setColorArgument(0,
vrTextureBlend::ARGUMENT_PREVIOUS_COLOR);
m_texBlendUnit2->setColorArgument(1,
vrTextureBlend::ARGUMENT_DIFFUSE_COLOR);

This extension may allow blending colors other then just a previous color and a current texture. Walking through the code, stage 0 may compute the dot product of the light vector and the normal retrieved from the normal map bound to stage 0. The light vector may then be stored in the texture blend color. The MODE_{—}DOT documentation may show that the RGB values should be between 0 and 1, not −1 to 1. Although not shown in the particular implementation set forth above, this may be effected by taking the normalized light vector and multiplying it by 0.5 and then adding 0.5.

Stage 1 may multiply the output of stage 0 by the diffuse color of the light source. This color may be passed in as the blend color for stage 1. So, a texture stage may be used, but texture information is not applied. Multiplication is used to factor in the blend color.

Stage 2 may adds the ambient light component. This may be done in the same manner as stages 0 and 1. However, in the implementation set forth above this is not the case so that the effects of other OpenGL lights may be preserved. Instead, stage 2 adds ARGUMENT_{—}DIFFUSE_{—}COLOR to the output of stage 1. This may include the color of the polygon at the pixel that is being textured. For this solution, only the ambient component of the sun/moon light source may be applied to the terrain, and not diffuse and specular. By doing this, the results of one or more other light sources in the scene may be added to this light source by means of the normal fixed function OpenGL pipeline.

The next stage may apply the illumination-neutral visual database to the now lit in coming pixel fragment:

m_texBlendUnit3 = new vrTextureBlend( );
m_texBlendUnit3
->setColorMode(vrTextureBlend::MODE_MODULATE);
m_texBlendUnit3->setCombineEnable(false);
m_texBlendUnit3->setColorArgument(0,
vrTextureBlend::ARGUMENT_PREVIOUS_COLOR);
m_texBlendUnit3->setColorArgument(1,
vrTextureBlend::ARGUMENT_TEXTURE_COLOR);

Although processors 112 and 114 are illustrated in FIG. 1 as separate processors, this illustration of processors 112 and 114 as separate entities is provided for simplicity in describing the overall functionality of system 110. In some implementations, both of processors 112 may be implemented by a single processing unit (or group of processing units).

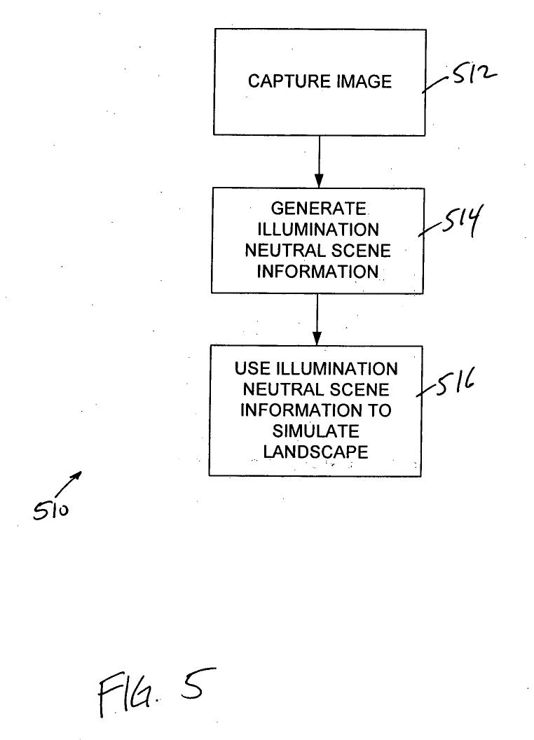

FIG. 5 illustrates a method 510 of creating a simulation of a terrain. In some embodiments, various operations within method 510 may be implemented and/or executed by system 110. However, these embodiments are not limiting, and other embodiments exist in which various operations included in method 510 may be implemented and/or executed by components not shown or described as being a part of system 110.

In an operation 512 an image of the terrain may be captured. The image may include one or more satellite images, one or more aerial images, and/or other images. In an operation 514 an illumination-neutral visual database may be generated based on the image of the terrain captured in operation 512. In one implementation, operation 514 may be executed by processor 112 of system 110. In an operation 516 the terrain may be simulated using the illumination-neutral visual database generated in operation 514. In one implementation, operation 516 may be executed by processor 114 of system 110.

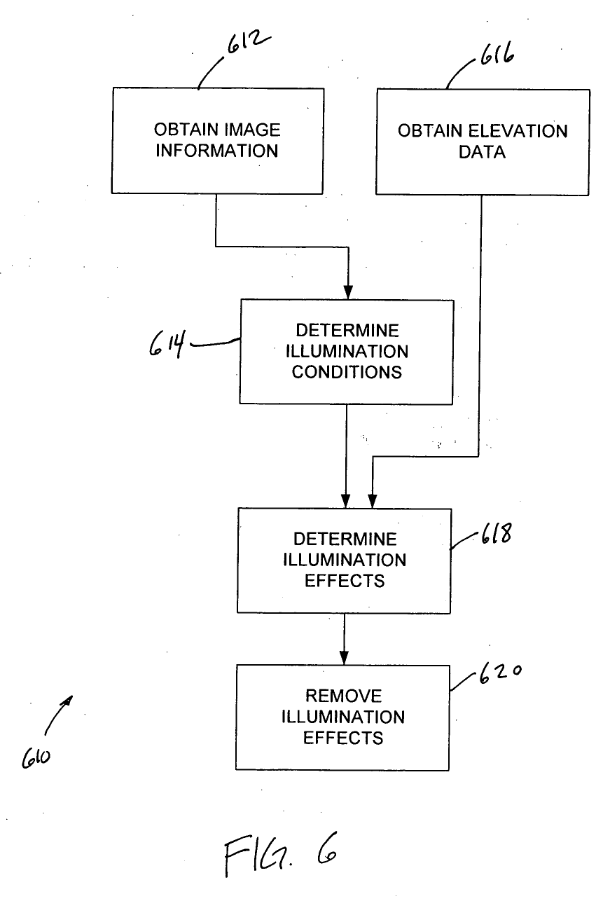

FIG. 6 illustrates a method 610 of generating an illumination-neutral visual database associated with a terrain. In one implementation, operation 514 of method 510 may include some or all of the operations included method 610. In some embodiments, various operations within method 610 may be implemented and/or executed by system 110. However, these embodiments are not limiting, and other embodiments exist in which various operations included in method 610 may be implemented and/or executed by components not shown or described as being a part of system 110.

In an operation 612 image information related to an image of the terrain may be obtained. The image information may include a capture time at which the image was captured, location information related to the location of the terrain, position information related to a position from which the image was captured, and a visual database that enables a view of the terrain to be rendered. In one implementation, the image information may be obtained by processor 112 from input interface 118 in the manner described above.

In an operation 614 one or more illumination conditions associated with the image of the terrain may be determined. The illumination conditions may be determined based on the image information determined in operation 612. In one implementation, the illumination conditions may be determined by illumination conditions module 122 of processor 112 as described previously.

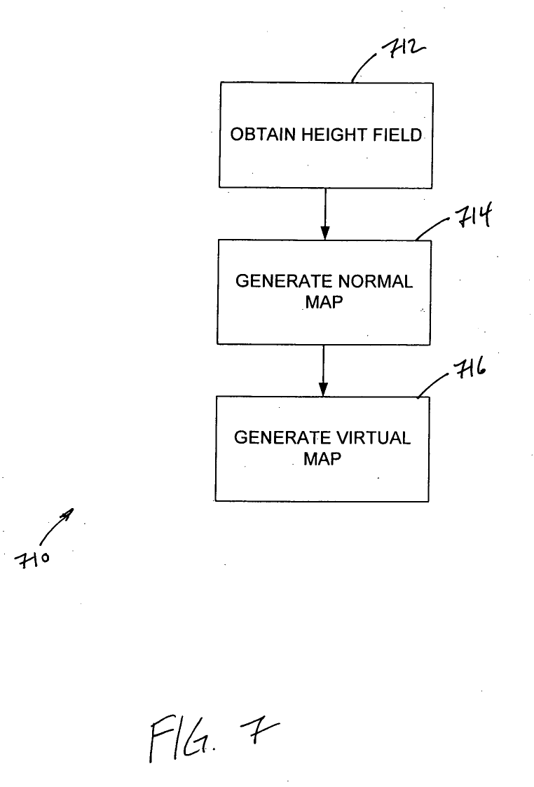

In an operation 616 elevation data associated with the terrain may be obtained. In one implementation, the elevation data may include elevation data obtained by processor 112 from input interface 118, as was set forth above. According to some implementations, obtaining the elevation data may include processing the elevation data, as will be discussed further below with respect to FIG. 7.

In an operation 618, one or more illumination effects may be determined. The one or more illumination effects may be determined based on the illumination conditions determined in operation 614 and the elevation data obtained in operation 616. In one implementation, the illumination effects may be determined by illumination effects module 126 of processor 112 in the manner described above.

In an operation 620, one or more illumination effects may be removed from visual database associated with the terrain. The visual database may include the visual database obtained at operation 612. The illumination effects may include the illumination effects determined at operation 618. In one implementation, the illumination effects may be removed from the visual database by effects removal module of processor 112, as was previously set forth.

FIG. 7 illustrates a method 710 of processing elevation data related to the terrain. In one implementation, some of all of the operations of method 710 may be performed in operation 616 of method 610. In some embodiments, various operations within method 710 may be implemented and/or executed by system 110. However, these embodiments are not limiting, and other embodiments exist in which various operations included in method 710 may be implemented and/or executed by components not shown or described as being a part of system 110.

In an operation 712 a height field that reflects the height of the terrain at predetermined positions (e.g., at predetermined coordinate intervals). The height field may include one or more DTED files, and/or other types of suitable files. In one implementation, the height field may be obtained by processor 112 from input interface 118 as described above.

In an operation 714 a normal map may be generated from the height field. In one implementation, the normal map may be generated by normal map module 120 of processor 112 in the manner discussed above.

In an operation 716 a virtual texture may be generated from the normal map. In one implementation, the virtual texture may be generated by elevation virtual texture module 122 of processor 112 as previously set forth.

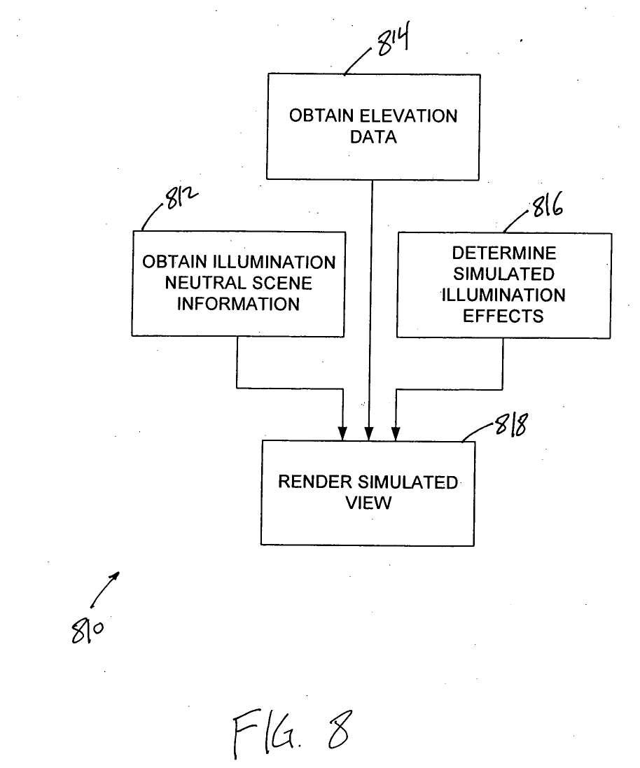

FIG. 8 illustrates a method of simulating a terrain using an illumination-neutral visual database. In one implementation, operation 516 of method 510 may include some or all of the operations included method 810. In some embodiments, various operations within method 810 may be implemented and/or executed by system 110. However, these embodiments are not limiting, and other embodiments exist in which various operations included in method 810 may be implemented and/or executed by components not shown or described as being a part of system 110.

In an operation 812 an illumination-neutral visual database associated with the terrain may be obtained. In one implementation, the illumination-neutral visual database may include the illumination-neutral visual database provided by operation 620 of method 610. In one implementation, the illumination-neutral visual database may be obtained by processor 114 from electronic storage 116 and/or processor 112 as described above.

In an operation 814 elevation data associated with the terrain may be obtained. In one implementation, the elevation data may include elevation data provided by operation 616 of method 610. In one implementation, the elevation data may be obtained by processor 114 from electronic storage 116 and/or processor 112 in the manner previously discussed.

In an operation 816 one or more simulated illumination conditions may be determined. In one implementation, the simulated illumination conditions may be determined by simulated illumination conditions module 132 of processor 114 as set forth above.

In an operation 818 a simulated view of the terrain may be rendered. The simulated view of the terrain may be rendered to include one or more simulated illumination effects. The simulated view of the terrain may be rendered from the illumination-neutral visual database using the elevation data and the simulated illumination conditions to add the simulated illumination effects. In one implementation, the simulated view may be rendered by the view rendering module 134 of processor 114 as described previously.

Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A method of creating a simulation of a terrain, the method comprising:
obtaining elevation data associated with a terrain;
obtaining image information associated with an image of the terrain, wherein the image information comprises a capture time at which the image was captured, location information related to the location of the terrain, and a visual database that enables a view of the terrain to be rendered;
estimating one or more illumination conditions at the location of the terrain at the capture time based on at least a portion of the image information;
determining one or more illumination effects of the illumination conditions in the image information based on the illumination conditions and the elevation data; and
removing the determined illumination effects from the visual database to create an illumination-neutral visual database that enables an illumination-neutral view of the terrain to be generated.

2. The method of claim 1, further comprising:
generating a simulated view of the terrain, wherein generating the simulated view comprises:
obtaining one or more simulated illumination conditions; and
rendering the simulated view of the terrain including one or more simulated illumination effects, wherein the simulated view is rendered from the illumination-neutral visual database and the simulated illumination conditions.

3. The method of claim 2, wherein obtaining one or more simulated illumination conditions comprises obtaining simulation information, wherein the simulation information includes a simulation time, and determining the simulated illumination conditions based on the simulation information.

4. The method of claim 1, wherein the elevation data comprises a normal map of the terrain.

5. The method of claim 4, wherein obtaining the elevation data comprises obtaining one or more terrain elevation files associated with the terrain and generating a normal map of the terrain from the terrain elevation files.

6. The method of claim 1, wherein the elevation data comprises generating a virtual texture of a normal map of the terrain.

7. The method of claim 6, wherein obtaining the elevation data comprises obtaining one or more terrain elevation files associated with the terrain, generating a normal map of the terrain from the terrain elevation files, and generating a virtual texture of the normal map.

8. The method of claim 1, wherein the visual database comprises three-dimensional geometrical information associated with the terrain.

9. The method of claim 1, wherein the illumination-neutral visual database comprises a virtual texture.

10. The method of claim 1, wherein the illumination conditions comprise positional information associated with a light source.

11. The method of claim 10, wherein the light source is the sun.

12. A system for creating a simulation of a terrain, the system comprising:
an input interface that enables elevation data associated with a terrain and image information associated with an image of the terrain to be input to the system, wherein the image information comprises a capture time at which the image was captured, location information related to the location of the terrain, and a visual database that enables a view of the terrain to be rendered;
a processor that executes an illumination conditions module, an illumination effects module, and an effects removal module; and
electronic storage;
wherein the illumination conditions module estimates one or more illumination conditions at the location of the terrain at the capture time based on at least a portion of the image information;
wherein the illumination effects module determines one or more illumination effects of the illumination conditions in the image information based on the illumination conditions and the elevation data;
wherein the effects removal module removes the determined illumination effects from the visual database to create an illumination-neutral visual database that enables an illumination-neutral view of the terrain to be generated; and
wherein the illumination-neutral visual database is stored in the electronic storage.

13. The system of claim 12, further comprising:
a second processor that generates a simulated view of the terrain, wherein generating the simulated view comprises:
obtaining one or more simulated illumination conditions;
accessing the illumination-neutral visual database stored in the electronic storage; and
rendering the simulated view of the terrain including one or more simulated illumination effects from the illumination-neutral visual database and the simulated illumination conditions.

14. The system of claim 13, wherein obtaining one or more simulated illumination conditions comprises obtaining simulation information, wherein the simulation information includes a simulation time, and determining the simulated illumination conditions based on the simulation information.

15. The system of claim 12, wherein the elevation data comprises a normal map of the terrain.

16. The system of claim 12, wherein the elevation data comprises one or more terrain elevation files associated with the terrain, wherein the processor generates a normal map of the terrain from the terrain elevation files, and wherein the illumination effects module uses the normal map to determine the illumination effects.

17. The system of claim 12, wherein the elevation data comprises one or more terrain elevation files associated with the terrain, wherein the processor generates a normal map of the terrain from the terrain elevation files, wherein the processor generates a virtual texture of the normal map, and wherein the illumination effects module uses the normal map to determine the illumination effects.

18. The system of claim 12, wherein the visual database comprises three-dimensional geometrical information associated with the terrain.

19. The system of claim 12, wherein the illumination-neutral visual database comprises a virtual texture.

20. The system of claim 12, wherein the illumination conditions comprise positional information associated with a light source.

21. The system of claim 20, wherein the light source is the sun.
